(19) United States
(12) Patent Application Publication
(10) Pub. No.: US 2014/0051385 A1
(43) Pub. Date: Feb. 20, 2014

(54) TELECOMMUNICATION BEHAVIOR STATISTICAL ANALYSIS SYSTEM

(71) Applicant: SYSTEX CORPORATION, TAIPEI CITY (TW)

(72) Inventors: DAH-MING LEE, NEW TAIPEI CITY (TW); TSUNG-YING LIN, TAOYUAN COUNTY (TW); SHU-LI TSWEI, TAIPEI CITY (TW)

(73) Assignee: SYSTEX CORPORATION, TAIPEI CITY (TW)

(21) Appl. No.: 13/948,298

(22) Filed: Jul. 23, 2013

(30) Foreign Application Priority Data
Aug. 17, 2012 (TW) 101129905

(51) Int. Cl. H04W 4/00

(52) U.S. Cl. CPC H04W 4/003
USPC 455/406; 455/405

(57) ABSTRACT

A telecommunication behavior statistical analysis system is disposed to a telecommunication machine room to gather statistics of and analyze motion behaviors of at least a mobile phone user in an application store. The system receives a plurality of transmission data from a telecommunication machine room through a receiving module and collects data to form a plurality of behavior information of the same mobile phone user and then obtains platform information, a target program, a request time and a request content of requests through analysis of a filter module. Request times, time and motion contents of each target program are performed with statistic and analysis by utilizing a processing module so that at least a statistical table is drawn and displayed in a display module. Accordingly, the telecommunication operator could easily handle consumers' favorite and purchasing tend with respect to different kinds of application programs applied in mobile phones.

### CROSS-REFERENCE TO RELATED APPLICATIONS

This non-provisional application claims priority under 35 U.S.C. §119(a) on Patent Application No(s). 101129905 filed in Taiwan, R.O.C. on Aug. 17, 2012, the entire contents of which are hereby incorporated by reference.

### BACKGROUND OF THE INVENTION

1. Field of the Invention

The invention relates to a technical field of telecommunication data transmission monitoring, and more particularly to a telecommunication behavior statistical analysis system allowing telecommunication operators to handle consumers' favorite and purchasing with respect to different kinds of application programs applied in mobile phones by gathering statistics and analyzing a great quantity of telecommunication transmission data.

2. Description of the Related Art

Application Store (App store) is originally a platform name of an application program publishing platform established by Apple Inc. for its products of iPhone, iPod, iPad and the like to allow consumers to browse or download different types of free or pay programs such as games, schedule management, dictionaries, gallery and finance programs, and Apple Inc. successfully creates huge business benefits through advertisements of free application programs and sale revenue of pay application programs so as to bring about new operation practice in telecommunication markets. With success of App. Store, related telecommunication operators also provide their App. Stores, such as Android Market, Google Play Store and Samsung Apps. The name of App Store is no longer owned by Apple Inc. and is a software platform that widely provides different types of micro-programs. At the same time, the development of mobile phone application programs starts. Currently, mobile phone application programs become indispensable and reliable tools for mobile phone users in daily life. Therefore, handling the trend of mobile phone application programs to earn the maximum business benefits becomes issues concerned by each telecommunication operator. A lot of telecommunication operators build data index after utilizing search engines to collect logs of machine room equipment so that the telecommunication operators can build operation procedures of customized search, monitor or report production. Afterward, the foregoing logs are composed of complex code numbers and may not be easily interrupted. The logs are enormous and may not be easily integrated. Consequently, the telecommunication operators is difficult to integrate data and unable to obtain an ideal analysis result to reduce analysis accuracy.

Therefore, providing precise analysis reports for the telecommunication operator to conveniently allow the telecommunication operators supplying mobile phone users with value added services and further establishing operation plan to create good business profitable formula are an issue to be overcome.

### SUMMARY OF THE INVENTION

Therefore, in view of the foregoing shortcomings, it is a primary objective of the present invention to provide a telecommunication behavior statistical analysis system so that the telecommunication operator can easily understand consumers' favorite and purchasing with respect to different kinds of application programs applied in mobile phones, thereby providing precise business services.

According to the object of the invention, the telecommunication behavior statistical analysis system is disposed in a telecommunication machine room to gather statistics of and analyze motion behaviors performed by at least a mobile phone user through a network after linking an application store and includes a receiving module, a filter module, a processing module and a display module. The receiving module is electrically connected to the telecommunication machine room and the filter module. The processing module is electrically connected to the filter module and the display module. The receiving module receives a plurality of transmission data of the telecommunication machine room to analyze and obtain a plurality of time data, a plurality of identification data, a plurality of target data and a plurality of motion data and collects the same identification data to integrate the plurality of time data, the plurality of target data and the plurality of motion data having relations to form a plurality of behavior information corresponding to the same mobile phone user. The filter module receives the plurality of behavior information and analyzes identification data of behavior information to obtain platform information of the mobile phone user and filters time data, target data and motion data of behavior information to obtain a request time, a request content and a program code of a target program from request motions of the mobile phone user. The processing module receives platform information, request time, the request contents and the program codes. The processing module is linked to the application store (App store) to search the program code so as to obtain a program name and a program category corresponding to the target program. The processing module gathers statistics of and analyzes the request times of each target program, the corresponding request time and the request contents to draw at least a statistical table. Further, the display module receives platform information, the request time, the program names, the program categories and the statistical table.

The receiving module is disposed a search engine for collecting transmission logs of the telecommunication machine room to form transmission data. Identification data comprises at least one of a mobile phone number, an International Mobile Subscriber Identification Number (IMSI), an International Mobile Equipment Identification Number (IMEI) and an internet protocol (IP). The filter module is to analyze the IMSI or the IMEI to obtain platform information such as Android Download manager, iTuns or Mac App Store and the like. Accordingly, the telecommunication operator can easily choose cooperation companies based upon the usage of the platform.

To allow the telecommunication operator easily understanding the development trend of different kinds of mobile phone application programs, the processing module obtains a program price and a program provider corresponding to the target program. The statistical table is a downloading timing diagram of each target program, a proportional graph of downloading times or a price curve diagram of each time point. Accordingly, the extremely hot application program category can be known, and consumer trend can be further handled to correctly plan the research and development directions.

Therefore, the telecommunication behavior statistical analysis system of the invention is disposed to the search engine to analyze motion behaviors of browsing, downloading or purchasing the each mobile phone application program and performed by each consumer and provides clear statistical table so that telecommunication operators can easily handle consumers' trend and preference to precisely market related products to improve the transaction.

### BRIEF DESCRIPTION OF THE DRAWINGS

The detailed structure, operating principle and effects of the present invention will now be described in more details hereinafter with reference to the accompanying drawings that show various embodiments of the invention as follows.

FIG. 1 is a system block diagram according to a preferred embodiment of the invention;

FIG. 2 is an analysis flowchart according to a preferred embodiment of the invention;

FIG. 3 is a screen diagram according to a preferred embodiment of the invention; and

FIG. 4 is a next screen diagram according to a preferred embodiment of the invention.

### DETAILED DESCRIPTION OF THE PREFERRED EMBODIMENTS

The technical content of the present invention will become apparent by the detailed description of the following embodiments and the illustration of related drawings as follows.

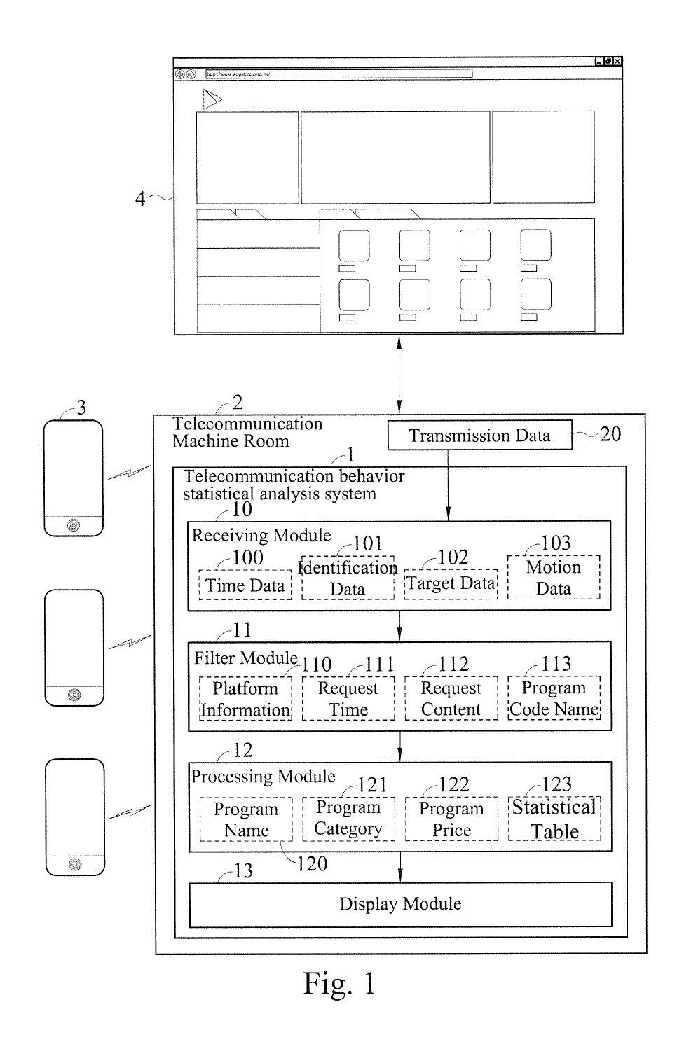

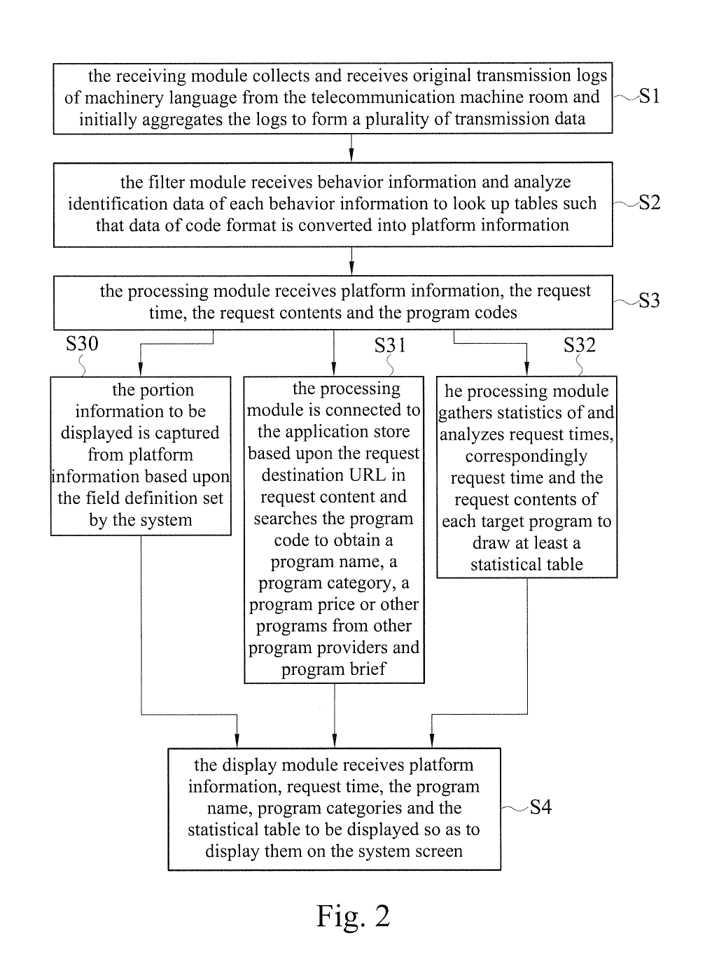

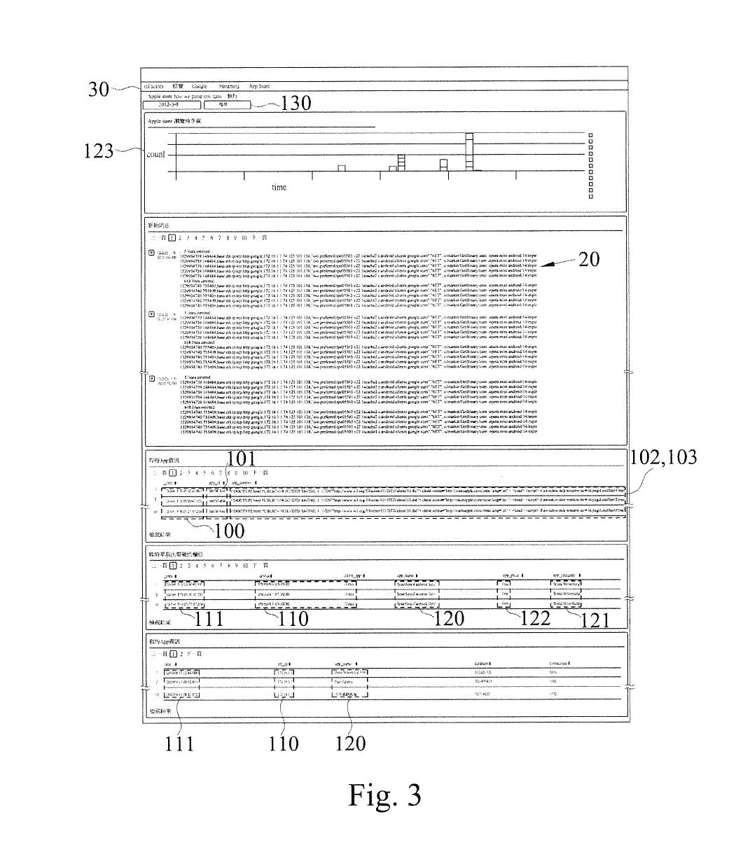

With reference to FIG. 1 to FIG. 3 for a system block diagram, an analysis flowchart and a screen schematic diagram according to a preferred embodiment of the invention are respectively depicted. As shown in the figures, when a plurality of mobile phone users 3 is respectively connected to an application store (App. store) 4 to perform motion behaviors of browsing web pages, downloading free programs or buying pay programs through a network, a telecommunication machine room 2 taken as a data transmission station will generate a huge transmission logs to record telecommunication behaviors each time. Therefore, to allow telecommunication operators to clearly handle popularity and consumer trends of different mobile phone application programs, the telecommunication behavior statistical analysis system 1 is disposed in the telecommunication machine room 2 to gather statistics and analyze the foregoing motion behaviors and permit each telecommunication operator to define each display field through a system screen to match different usage behaviors and preference, thereby improving system practicality. The telecommunication behavior statistical analysis system 1 includes a receiving module 10, a filter module 11, a processing module 12 and a display module 13. The receiving module 10 is disposed with a search engine and electrically connected to the filter module 11 and communication equipment of the telecommunication machine room 2, such as servers, and the processing module 12 is electrically connected to the filter module 11 and the display module 13.

When the telecommunication operator selects execution motion, for example, after series of raw transmission logs are displayed in columns and a search button 130 on the screen is pressed by defining an analysis deadline, the analysis flow of the telecommunication behavior statistical analysis system 1 is shown as the following:

Firstly, in step S1, the receiving module 10 collects and receives original transmission logs of machinery language from the telecommunication machine room 2 and initially aggregates the logs to form a plurality of transmission data 20 that is directly displayed in columns. The transmission data 20 is analyzed to obtain a plurality of time data 100, a plurality of identification data 101, a plurality of target data 102 and a plurality of motion data 103. The same identification data 101 is collected to integrate time data 100, target data 102 and motion data 103 having relations to form a plurality of behavior information corresponding to the same mobile phone user 3, and information then is transmitted to the filter module 11, wherein time data 103 is a time record of each motion behavior. The identification data 101 and the target data 102 are shown as codes and respectively cover the mobile phone user 3 and the network environment, device information, mobile phone number, IMSI, IMEI, IP and installed software of its connection terminal. The motion data 103 is behaviors of browsing, downloading or feedback requested by the mobile phone user 3 through the network.

In step S2, the filter module 11 receives behavior information and analyze identification data 101 of each behavior information to look up tables such that data of code format is converted into platform information 110 of the mobile phone user 3 such as device name and number of iPhone/4.3.1 (3;16 GB), iPad and the like, 172.16.1.1 address, iTunes application software or browser types and versions. The filter module 11 filters time data 100, target data 102 and motion data 103 of each behavior information to obtain messages of a request time 111, a request content 112, a program code 113 of a target program and other processing outcomes. It should be noted that the request content 112 can include messages of a request destination URL, a device code, a browsing request, downloading or purchasing behavior, a request result, communication time and data packet lengths and the like so that simpler or complete analysis result can be provided real-time in accordance with different setting of the telecommunication operator.

Next, in step S3, after the processing module 12 receives platform information 110, the request time 111, the request contents 112 and the program codes 113, step S30 is executed: portion information to be displayed is captured from platform information 110 based upon the field definition set by the system. Simultaneously, step S31 is executed: the processing module 12 is connected to the application store 4 based upon the request destination URL in the request content 112 and searches the program code 113 to obtain a program name 120, a program category 121, a program price 122 or other programs from other program providers and program brief. In step S32: the processing module 12 gathers statistics of and analyzes request times, corresponding request time 111 and the request contents 112 of each target program to draw at least a statistical table 123.

Finally, in step S4, according to the system field defined by the telecommunication operator, the display module 13 receives the platform information 110, the request time 111, the program name 120, the program categories 121 and the statistical table 123 to be displayed so as to display them on the system screen. In the embodiment, the statistical table 123 can be a timing diagram of receiving the browsing request for the application store 4 to count views of browsing different kinds of mobile phone application programs in each time.

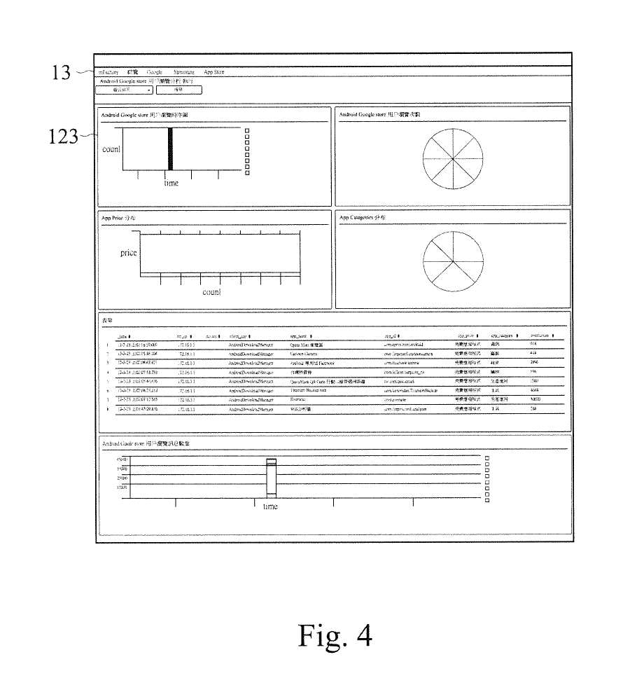

Alternatively, the display module 13 can display the screen shown in FIG. 4 for a next screen diagram according to a preferred embodiment of the invention. According to setting manner, telecommunication behavior analysis result within 30 days can be clearly displayed by directly taking the statistical tables 123 having a browsing timing diagram of each target program, a proportional graph of browsing times of each target program, a price distributed curve diagram of each target program and a proportional graph of category of each target program. Further, the statistical table 123 can also be a downloading timing diagram of each target program, the proportional graph of downloading times of each target program or the price curve diagram of each time so that the telecommunication operator can conveniently and crossly compare the time, price and consumer groups with the development effect of a mobile phone application program to handle correct market trends.

While the means of specific embodiments in the present invention has been described by reference drawings, numerous modifications and variations could be made thereto by those skilled in the art without departing from the scope and spirit of the invention set forth in the claims. The modifications and variations should in a range limited by the specification of the present invention.

What is claimed is:

1. A telecommunication behavior statistical analysis system disposed in a telecommunication machine room to gather statistics and analyze motion behaviors performed by at least a mobile phone user after connecting an application store through a network, comprising:
a receiving module, electrically connected to the telecommunication machine room, for receiving a plurality of transmission data of the telecommunication machine room to analyze and obtain a plurality of time data, a plurality of identification data, a plurality of target data and a plurality of motion data and collecting the same identification data to integrate the plurality of time data, the plurality of target data and the plurality of motion data having relations so as to form a plurality of behavior information corresponding to the same mobile phone user;
a filter module, electrically connected to the receiving module, for receiving behavior information, the filter module analyzing identification data of behavior information to obtain platform information of the mobile phone user and filtering time data, target data and motion data of each behavior information to obtain a request time, a request content and a program code of a target program of the request motion of the mobile phone user;
a processing module, electrically connected to the filter module, for receiving platform information, the request time, the request content and the program codes, the processing module linking the application store to search the program code to obtain a program name and a program category corresponding to the target program; the processing module gathering statistics of and analyzing request times, the request time and the request contents of each target program so as to draw at least statistical table; and
a display module, electrically connected to the processing module, for receiving and displaying the platform information, the request time, the program names, the program categories and the statistical table.

2. The telecommunication behavior statistical analysis system of claim 1, wherein the receiving module is disposed a search engine for collecting transmission logs of the telecommunication machine room to form transmission data.

3. The telecommunication behavior statistical analysis system of claim 2, wherein identification data comprises at least one of a mobile phone number, an International Mobile Subscriber Identification Number (IMSI), an International Mobile Equipment Identification Number (IMEI) and an internet protocol (IP).

4. The telecommunication behavior statistical analysis system of claim 3, wherein the filter module is to analyze the IMSI or the IMEI to obtain platform information.

5. The telecommunication behavior statistical analysis system of claim 4, wherein the processing module obtains a program price and a program provider corresponding to the target program.

6. The telecommunication behavior statistical analysis system of claim 5, wherein the statistical table is a downloading timing diagram of each target program, a proportional graph of downloading times or a price curve diagram of each time point.
